(19) United States
(12) Patent Application Publication
(10) Pub. No.: US 2025/0111487 A1
(43) Pub. Date: Apr. 3, 2025

(54) AUTOMATIC AND ADAPTIVE REGION CONFIGURATION FOR DEWARPING A FISHEYE VIDEO STREAM

(71) Applicant: Konica Minolta Business Solutions U.S.A., Inc., San Mateo, CA (US)

(72) Inventor: Jie Kulbida, Broomfield, CO (US)

(73) Assignee: Konica Minolta Business Solutions U.S.A., Inc., San Mateo, CA (US)

(21) Appl. No.: 18/375,200

(22) Filed: Sep. 29, 2023

(51) Int. Cl. G06T 5/00; G06T 3/00; G06T 7/20; G06V 10/25; G06V 10/762; G06V 20/52

(52) U.S. Cl. CPC G06T 5/80; G06T 3/12; G06T 7/20; G06V 10/25; G06V 10/762; G06V 20/52; G06T 2207/10016; G06T 2207/20004; G06T 2207/30232

(57) ABSTRACT

A method of processing a video stream from a non-rectilinear (NR) camera includes: obtaining an activity score map that corresponds to a view of the NR camera; obtaining, from the NR camera, an NR image that includes the view of the NR camera; detecting motion in the NR image; generating an updated activity score map by incrementing the activity score map based on the detected motion in the NR image; performing clustering on the updated activity score map to identify a region of interest (ROI) in the NR image; generating dewarping information of the ROI based on a constraint of the NR camera (the dewarping information includes parameters to convert the ROI into a rectilinear output); and outputting the dewarping information of the ROI.

### BACKGROUND

Ultra wide-angle cameras (e.g., cameras configured with one or more fisheye lens, hemi-spheric dome cameras) are commonly used in security or surveillance applications. While these non-rectilinear (NR) cameras are useful for monitoring wide regions of the environment in which they are deployed, the captured video stream or images are severely distorted by the optical geometry. For example, when a fisheye camera is mounted on a ceiling, the vertical orientation of objects is relative throughout the image (i.e., oriented radially from the center of the image) rather than absolute (i.e., uniformly oriented along the vertical axis of the image). Furthermore, objects are severely distorted (e.g., compressed and warped) by the optical geometry near the edge of the field of view (FOV). One or more projection models may be used to transform the NR imagery into a rectilinear form that can be more easily interpreted by a user or detection models. A dynamic and computationally efficient (e.g., in terms of processor time/bandwidth, communication time/bandwidth) method of configuring the dewarping process for NR cameras is desirable.

### SUMMARY

In general, one or more embodiments of the invention relate to a method of processing a video stream from an NR camera. The method comprises: obtaining an activity score map that corresponds to a view of the NR camera; obtaining, from the NR camera, an NR image that includes the view of the NR camera; detecting motion in the NR image; generating an updated activity score map by incrementing the activity score map based on the detected motion in the NR image; performing clustering on the updated activity score map to identify a region of interest (ROI) in the NR image; generating dewarping information of the ROI based on a constraint of the NR camera (the dewarping information includes parameters to convert the ROI into a rectilinear output); and outputting the dewarping information of the ROI.

In general, one or more embodiments of the invention relate to a non-transitory computer readable medium (CRM) storing computer readable program code for processing a video stream from an NR camera. The computer readable program code causes a computer to: obtain an activity score map that corresponds to a view of the NR camera; obtain, from the NR camera, an NR image that includes the view of the NR camera; detect motion in the NR image; generate an updated activity score map by incrementing the activity score map based on the detected motion in the NR image; perform clustering on the updated activity score map to identify a region of interest (ROI) in the NR image; generate dewarping information of the ROI based on a constraint of the NR camera (the dewarping information includes parameters to convert the ROI into a rectilinear output); and output the dewarping information of the ROI.

In general, one or more embodiments of the invention relate to a system for processing a video stream from an NR camera. The system comprises a memory and a processor coupled to the memory. The processor is configured to: obtain an activity score map that corresponds to a view of the NR camera; obtain, from the NR camera, an NR image that includes the view of the NR camera; detect motion in the NR image; generate an updated activity score map by incrementing the activity score map based on the detected motion in the NR image; perform clustering on the updated activity score map to identify a region of interest (ROI) in the NR image; generate dewarping information of the ROI based on a constraint of the NR camera (the dewarping information includes parameters to convert the ROI into a rectilinear output); and output the dewarping information of the ROI.

Other aspects of the invention will be apparent from the following description and the appended claims.

### BRIEF DESCRIPTION OF DRAWINGS

FIGS. 1A-1B show a comparative example of an image of a rectilinear camera.

FIGS. 2A-2B show an example of an image of an NR non-rectilinear camera in accordance with one or more embodiments of the invention.

FIG. 3 shows a functional schematic of a system in accordance with one or more embodiments of the invention.

FIG. 4 show an NR image in accordance with one or more embodiments of the invention.

FIGS. 5A-5B show examples of processing an NR image in accordance with one or more embodiments of the invention.

FIGS. 6A-6C show examples of output rectilinear outputs in accordance with one or more embodiments of the invention.

FIGS. 7A-7B show examples of processing an NR image and rectilinear outputs in accordance with one or more embodiments of the invention.

FIG. 8 shows a flowchart for a method in accordance with one or more embodiments of the invention.

FIG. 9 shows a flowchart for a method in accordance with one or more embodiments of the invention.

FIG. 10 shows a schematic of a dewarping algorithm in accordance with one or more embodiments of the invention.

FIG. 11 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

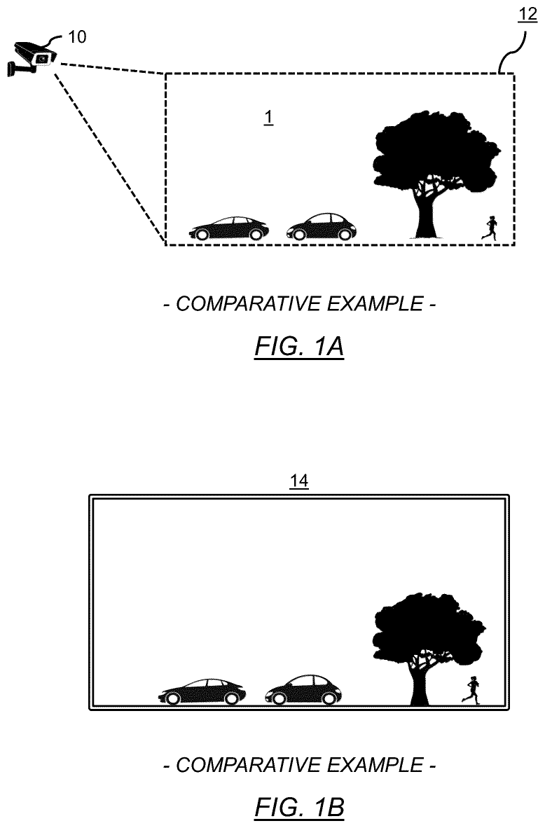

FIGS. 1A-1B show a comparative example of an image of a rectilinear camera 10.

In FIG. 1A, an example surveillance environment 1 includes two cars, one tree, and a person running away from the cars. A rectilinear camera 10 is positioned within the surveillance environment 1 to capture the two cars, the tree, and the person within a rectilinear FOV 12. As the rectilinear camera 10 monitors the surveillance environment 1, a series of rectilinear images 14 are produced.

As shown in FIG. 1B, the rectilinear image 14 produced by the rectilinear camera 10 contain an undistorted representation of the surveillance environment 1. Specifically, the two cars, the tree, and the person all have the same orientation and scale. Therefore, the entirety of the rectilinear image 14 or individual cropped regions can be analyzed using a consistent processing method. In intelligent surveillance applications, image data captured are processed by artificial intelligence (AI) algorithms for monitoring, detecting, and identification of threats or anomalies.

Most detection models (e.g., shape recognition, facial recognition) are intended for processing undistorted imagery, such as rectilinear image 14. However, the rectilinear FOV 12 in the rectilinear image 14 has a relatively narrow range that is limited by optical geometry of the rectilinear camera 10. Positioning the camera 10 farther from the surveillance environment 1 to monitor a larger area would result in a loss of detail. Therefore, it is common to use a NR camera, such as a wide-angle view camera (e.g., a hemispheric fisheye camera), to monitor a large surveillance environment 1.

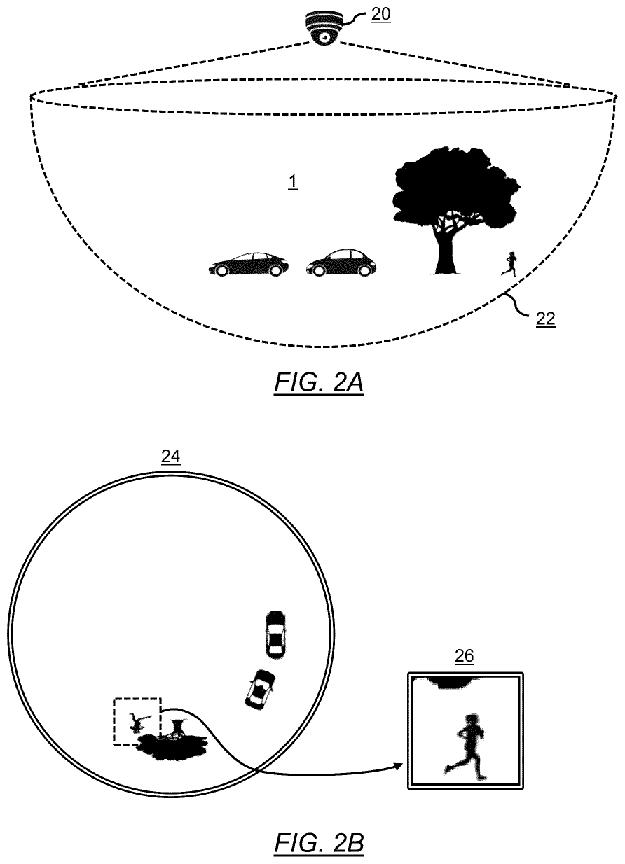

FIGS. 2A-2B show an example of an image of an NR non-rectilinear camera in accordance with one or more embodiments of the invention.

In FIG. 2A, the same example surveillance environment 1 (i.e., two cars, one tree, and the person running away from the cars) is monitored by a ceiling-mounted ultra wide-angle NR camera 20. The NR camera 20 is positioned above the surveillance environment 1 and includes a hemispherical FOV 22 that includes the two cars, the tree, and the person. As the NR camera 20 monitors the surveillance environment 1, a series of NR images 24 are produced.

As shown in FIG. 2B, the NR image 24 produced by the NR camera 20 contain a distorted representation of the surveillance environment 1. For example, each of the two cars, the tree, and the person have a different vertical orientation (e.g., in a radial clock scheme, vertical would be defined at 3 o'clock and 4 o'clock for the respective cars, approximately 6 o'clock for the tree and person). Furthermore, the proportions of each object in the NR image 24 are distorted along its local vertical axis (e.g., non-uniform stretching/compression along the height of the runner).

Because distortion in NR image 24 is largely unique to the exact lens configuration and orientation of the NR camera 20, most detection models would not be effective when presented with NR image 24. For example, machine learning (ML) algorithms are trained to identify objects based on training datasets built from vast databases including various images of an object. Because most photographers capture undistorted rectilinear images, the databases used to train ML algorithms are biased to rectilinear views of the object. As a result, the trained ML algorithm is likely to produce more erroneous results when presented with an NR image of the same object. For example, a real-time object recognition algorithm such as You Only Look Once (YOLO) could be applied to rectilinear image 14 with little to no preprocessing but would likely struggle to provide meaningful results if applied to NR image 24.

Therefore, individual regions of the NR image 24 must be processed (e.g., cropped, reoriented, transformed to remove distortion) to produce a rectilinear output 26. Various “dewarping” methods exist to transform an NR image 24 into format in which captured objects look similar to those in rectilinear image 14. For example, an equirectangular projection model may be used to unwrap a circular fisheye image into a panoramic format and a perspective model may be used to transform into rectilinear format.

In general, embodiments of the invention provide a method, a non-transitory CRM, and a system for processing a video stream from an NR camera. One or more embodiments are directed to configuring dewarping information (e.g., size, resolution, boundaries, orientation information) that identifies one or more ROIs in an NR image for transformation into a rectilinear format. The dewarping information is determined based on one or more constraints (e.g., optical geometry, processing power, frame rate, communication bandwidth) of the NR camera. For example, the claimed method may configure one or more rectilinear outputs 26 (images or video streams) without losing valuable content in the NR image 24 and while conforming to standard video or data processing techniques (e.g., image format, resolution, aspect ratio, computational resource limits).

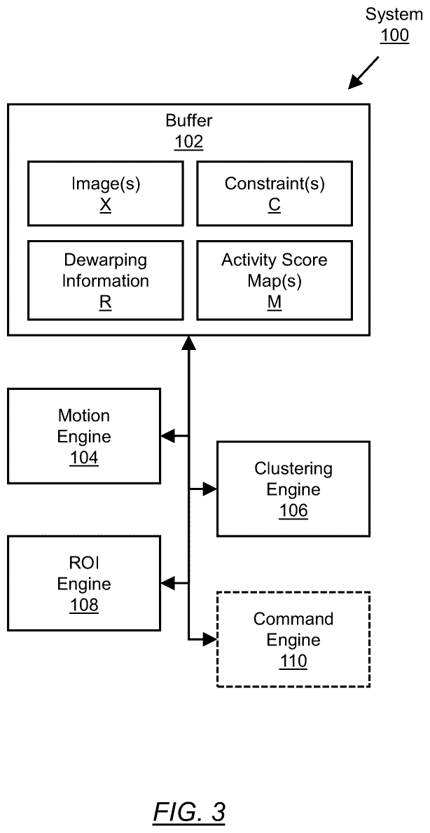

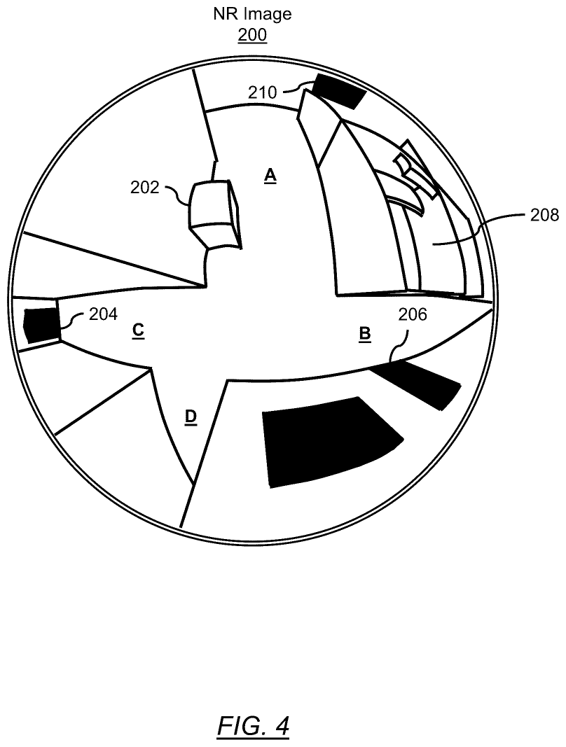

FIG. 3 shows a functional schematic of a system 100 in accordance with one or more embodiments of the invention.

The system 100 has multiple components, and may include, for example, a buffer 102, a motion engine 104, a clustering engine 106, an ROI engine 108, and, optionally, a command engine 110. Each of these components is discussed in further detail below.

The buffer 102 of the system 100 is configured to store any number of the following: image(s) (X); constraint(s) (C); dewarping information (R); and activity score map(s) (M). Each of these items is described in further detail below.

Each image (X) may be an NR image 24 obtained from a video stream from an NR camera 20, a section of the NR image 24, a rectilinear image (e.g., a rectilinear output image 26, a reference image, an image recognition template). In one or more embodiments, the buffer 102 may store a video recording or live video stream from the NR camera 20. The images (X) may be saved in the buffer 102 in any imaging format (e.g., file format, size, resolution, compression).

Each constraint (C) may be information related to the properties and/or configuration of the NR camera 20. For example, constraint information may include: an output resolution of the NR camera 20; an optical parameter of the NR camera 20 (e.g., focal lengths, lens distortion information); a frame rate of the NR camera; a communication bandwidth of the NR camera 20 or the surveillance system including the NR camera 20; a computational resource limit of the NR camera 20 or the surveillance system including the NR camera 20 (e.g., processing power, number of processing threads, video stream capacity (i.e., number of streams/processing thread/communication channels available for use)); control parameters of the NR camera 20 (e.g., motion capability, light mode capability (visible/infrared), processing modes); orientation constraint of the image recognition algorithm utilized by the NR camera 20; limitation of an ML algorithm utilized by the NR camera 20 (e.g., resolution/size limits of rectilinear output 26, required computational resources, processing thread allocation); number of outputs/ROIs. While the present description includes a limited number of examples, those having ordinary skill in the art will appreciate that alternative examples of constraints may be used without deviating from the gist of the invention.

Dewarping information (R) may be information that defines one or more ROIs in the NR image 24 for transformation into a rectilinear format. For example, coordinates within the NR image 24, dimensions, transformation parameters (e.g., projection type, coefficients for transformations), and/or labels (e.g., ROI identifiers, keywords) may be provided for each ROI in the dewarping information (R). In one or more embodiments, the dewarping information (R) may include weights or coefficients that are used to reconfigure the dewarping information (R) at a later time (e.g., when a stable change occurs in the surveillance environment 1).

Each activity score map (M) may be a representation of detected motion in the FOV 22 of the NR camera 20. For example, an activity score map (M) may be an image with the same dimensions as the original NR image 24, where each pixel indicates a level of activity within a corresponding location in the surveillance environment 1. For example, the activity score map (M) may be a 2D pixel map, whose dimension is the same as that of the original NR image 24, where each pixel corresponds to an activity score at that location in the NR image 24. In one or more embodiments, the activity score map (M) may be a monochromatic bitmap image where the pixel intensity indicates a number of times motion has been detected over a predetermined duration.

In one or more embodiments, the activity score map (M) may be binary (e.g., a single bit that determines whether a motion is detected or not), multibit (e.g., multiple bits to determine how strongly the pixel is emphasized), and/or multi-dimensional (e.g., multiple masks corresponding to different color channels, different spatial dimensions, different collaborators). While the present description focuses on a monochromatic bitmap, those having ordinary skill in the art will appreciate that alternative examples (e.g., conversion into vector format, multibit image for different types of motion (e.g., directionality, duration, repeatability), video map representing evolving motion pattens) may be used without deviating from the gist of the invention. The activity score map (M) may be saved in the buffer 102 in any format (e.g., file format, size, resolution, compression).

In one or more embodiments, the buffer 102 may include any other information required by the system 100 to execute the invention. For example, the buffer 102 may further include instructions for executing one or more transforms (H) (not shown). The transforms (H) may include any number of projection models or coordinate space transformations to convert an NR image into to a rectilinear output. For example, as part of the initialization of the system 100, the buffer 102 may be configured with one or more pixel map transformations that map coordinates of each pixel in the NR image 24 to a corresponding pixel location in the rectilinear output. Therefore, values (e.g., RGB or intensity values) at each pixel on the NR image 24 can be copied to the rectilinear output. Furthermore, any appropriate image processing transformation (e.g., rotation, translation, scale, skew, cropping, or any appropriate image processing function) or combination of image processing transformations, such as a convolution of one or more transformations, may be included.

The motion engine 104 of the system 100 is configured to detect motion in the NR image 24 obtained from the NR camera 20. In one or more embodiments, the motion engine 104 may compare the NR image 24 to one or more images (X) from the buffer 102 (e.g., a previous frame from the NR camera 20) and identify movement by differences in pixel values that exceed a predetermined threshold.

In one or more embodiments, the motion engine 104 may identify movement based on object analysis (e.g., detecting and analyzing foreground objects in NR image 24). For example, an object of interest may be identified based on an image segmentation technique (e.g., thresholding, edge detection, region extraction) and tracked over one or more images (X) in the buffer 102. Identified objects may be filtered based on one or more characteristics (e.g., size, shape, color, contrast) to provide more reliable motion detection (e.g., less sensitive to noise, changes in ambient light). Changes in measured object characteristics (e.g., change in size implies the object is moving toward/away from NR camera 20) may be recorded as detected motion in the NR image 24.

Any appropriate number or combination difference detection algorithms may be used to detect motion in the NR image 24.

In one or more embodiments, the motion engine 104 accepts an NR image 24 as an input and outputs an activity score map (M) (e.g., generates a new map, updates a stored map).

The clustering engine 106 of the system 100 is configured to identify high intensity regions within an activity score map (M). The clustering engine 106 may utilize one or more clustering algorithms (e.g., K-means clustering, centroid based clustering, hierarchy clustering) to group collections of pixels (or areas) in the activity score map (M). The clustering engine 106 may define the center and/or boundaries of each cluster to define each corresponding ROI in the NR image 24.

In one or more embodiments, the clustering engine 106 accepts an activity score map (M) as an input and outputs a portion of the dewarping information (R) (e.g., generates new information, updates existing information).

In one or more embodiments, the clustering engine (106) may perform pattern recognition or any appropriate content analysis to identify a stable change in the activity score map (M). A stable change may be any change in a region that persists for a predetermined amount of time. For example, the stable change may be characterized by a change in an intensity level of a pixel between two different captured images (i.e., a value threshold) and/or a change in the number of pixels within a region that a predetermined threshold (i.e., a count threshold). The predetermined amount of time may be any appropriate value to distinguish stable changes from unwanted artifacts (e.g., camera obstruction, poor quality image, interrupted video feed). In one or more embodiments, the method of detecting the stable change (e.g., image recognition programs, predetermined threshold values, predetermined time intervals) may be dynamically updated.

The ROI engine 108 of the system 100 is configured to define, or refine the definition of ROIs within the NR image 24. The ROI engine 108 may utilize one or more algorithms or transforms to define each ROI such that the NR image 24 can be reconfigured into one or more rectilinear outputs 26 (i.e., generates or updates dewarping information (R) for that ROI). Furthermore, the ROI engine 108 determines the dewarping information in view of the constraints (C) of the NR camera 20 (i.e., the camera itself and the system supporting the camera). For example, the ROI engine 108 may use a cluster location determined by the clustering engine 106 and a projection transform stored in the buffer 102 to define a region in the NR image 24 that can be converted into a rectilinear output 26. Based on the constraints (C), the region defined by the dewarping information may be limited in size, given a specific aspect ratio, etc. Furthermore, the ROI engine 108 may prioritize (e.g., rank, categorize, or otherwise differentiate) the regions in the NR image 24 when a limited number of ROIs are supported by the NR camera 20.

In one or more embodiments, the ROI engine 106 accepts one or more constraints (C) as an input and outputs a portion of the dewarping information (R) (e.g., generates new information, updates existing information).

The command engine 110 of the system 100 is configured to execute one or more commands. For example, the command engine 110 may perform dewarping of the NR image 24 based on the dewarping information (R) when the system 100 is configured to both generate the dewarping information and provide the rectilinear output.

In one or more embodiments where the NR camera 20 is configured to accept commands (e.g., pan/tilt/zoom movements to reorient the FOV, frame rate changes, camera mode changes), the system 100 may provide feedback to the NR camera 20 to improve image acquisition. For example, if the motion detection engine has difficulty identifying movement in a dark image at night, the command engine 110 may cause the NR camera 20 to switch to an infrared mode for better image contrast. In one or more embodiments, the command engine 110 may regulate the frame rate of the NR camera 20 to match the throughput rate of the dewarping process to prevent processing bottlenecks.

In one or more embodiments, the command engine 110 may send a signal to another system based on the analysis performed by the system 100 (e.g., notify security of a stable change in the activity score map).

Those having ordinary skill in the art will appreciate that various commands and/or signals may be used without deviating from the gist of the invention.

Although the system 100 is described with respect to functional components 102, 104, 106, 108, and 110, in other embodiments of the invention, the system 100 may have more or fewer functional components. In addition, each functional component 102, 104, 106, 108, and 110, may be omitted, utilized multiple times (e.g., in serial or parallel), or reordered based on aspects of any given application.

Each of the functional components of system 100 may be implemented in hardware (i.e., circuitry), software (e.g., instructions executed by hardware), or any combination thereof. The functions of each functional component may be shared or performed entirely by other functional components. In addition, each functional component may be executed by the same computing device or on different computing devices connected by a network of any size having wired and/or wireless segments.

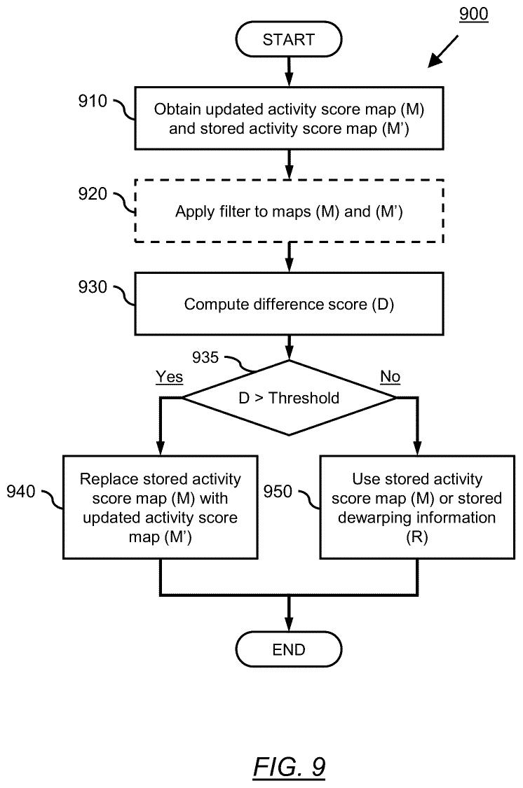

By utilizing the above described engines, the system 100 can configure a method for processing imagery generated by an NR camera, as described in further detail below with respect to FIG. 8. Furthermore, the system 100 can respond to stable changes in the environment captured by the NR camera, as described in further detail below with respect to FIG. 9. Stable changes in the environment may result from new traffic patterns (e.g., reorganizing of furniture), changes in personnel, changes in security protocols, or any prompt. In one or more embodiments, the system 100 advantageously configures processing of imagery generated by an NR camera to process the most relevant information while operating within the hardware constraints of the NR camera (e.g., resolution, optical field of view, transmission bandwidth, processing bandwidth). In this manner, the system 100 is flexible enough to integrate with new surveillance systems or deployed surveillance systems with more technological limits.

FIG. 4 show an NR image 200 in accordance with one or more embodiments of the invention.

NR image 200 is an overhead view of an office space captured through a fisheye camera. The office space include a series of pathways A, B, C, D that intersect below the fisheye camera. Each pathway A, B, C, D leads to a different section of the office and therefore experiences different foot traffic patterns. Pathway A leads to a multi-function peripheral device 202 (e.g., scanner/copier/print/fax machine) and to a window 210. Pathway B leads to a cubicle 208 and a meeting room 206. Pathway C leads to the exit 204. Pathway D leads to another area of the office space.

The FOV distortion due to the ultra wide-angle fisheye lens means the NR image 200 would not be directly useful for processing with AI/ML techniques. For example, identifying users of the multi-function peripheral device 202 would be difficult when the facial features are distorted by the fisheye projection. Therefore, the imagery from the NR camera may be processed in accordance with one or more embodiments of the invention to produce rectilinear outputs that can be input into said AI/ML techniques with better outcomes.

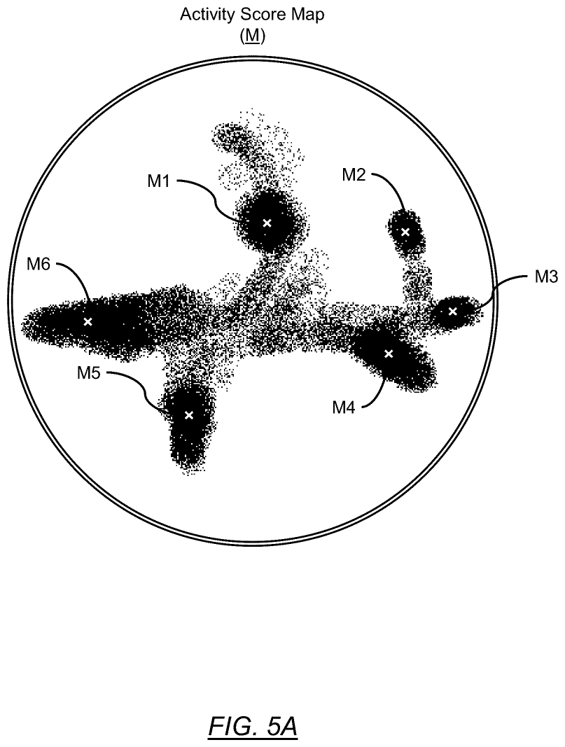

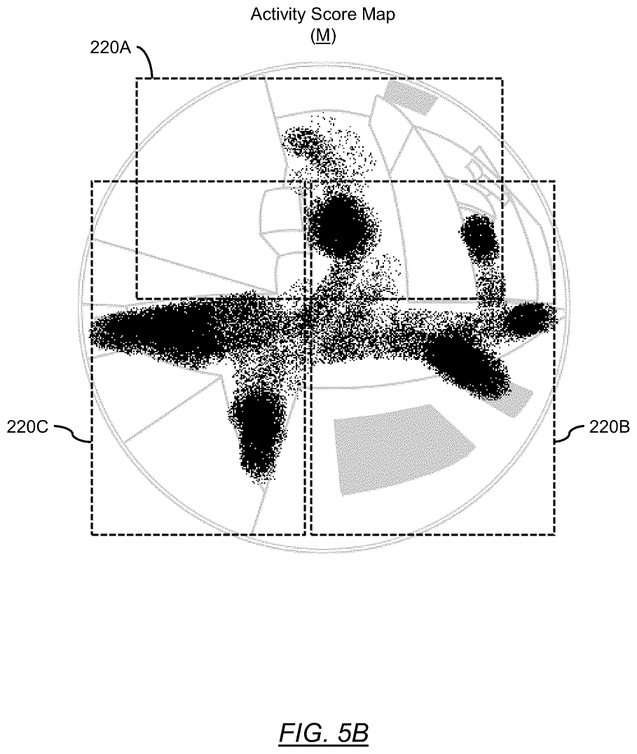

FIGS. 5A-5B show examples of processing an NR image in accordance with one or more embodiments of the invention.

FIG. 5A shows an activity score map (M) generated by comparing various frames of a video stream from the fisheye camera in the office space (e.g., multiple NR images 200 acquired at different times over a predetermined duration). While FIG. 5A shows a binary bitmap image (i.e., black pixel for area with movement above a threshold, white pixel for area with movement below a threshold), more detailed information may be represented by using more complex data formats. For example, pixel values in a grayscale image can indicate exactly how many instances of movement during the predetermined duration. A multibit image may include addition information (e.g., weight parameters for time of day/week/year, periodicity, frequency, direction) in one or more additional channels of the activity score map (M).

As shown in FIG. 5B, several active regions of the office space can be identified by the various clusters of pixels within the activity score map (M). Each cluster may be identified by a centroid or center of mass M1-M6. For example: cluster M1 corresponds to workers approaching the multi-function peripheral device 202 positioned in pathway A; cluster M2 corresponds to a worker moving in the cubicle 208; cluster M3 corresponds to workers entering/exiting the office space via pathway B; cluster M3 corresponds to workers entering the meeting room 206 in pathway B; cluster M5 corresponds to workers entering/exiting the office space via pathway D; cluster M6 corresponds to workers entering/exiting the office space via pathway C. Multiple ROIs 220 may be identified in the NR image 200 (shown as a transparent overlay on top of activity score map (M)) based on the identified cluster M1-M6.

In one or more embodiments, the ROIs 220 may be selected to include some or all of the identified clusters under a constraint (C) that each ROI must conform to a specified format (e.g., size, aspect ratio, orientation, acceptable amount of distortion based on the NR camera lens). This configuration constraint (C) may ensure that the processing of the NR image 200 is not bottlenecked.

For example, some fisheye cameras are equipped with on-camera dewarping capabilities that are limited by the processing power included in the camera (e.g., number of threads available to process ROIs, memory allocation for each ROI, input/output bandwidth or file size limits). Generating or communicating large rectilinear output files may overtax the system resulting in poor performance (e.g., delays, bottlenecking, lost frames). To avoid these problems, the NR camera may be configured to send raw NR images to a separate computing system (e.g., a server) with more computational resources to perform dewarping with fewer or different limitations (e.g., GPU limitations, AI/ML limitations, multithreading limitations). In either case, the ROIs 220 may be determined in accordance with one or more embodiments, and transmitted to the appropriate component of the surveillance system that performs the dewarping.

In one or more embodiments, the ROIs 220 may be selected to include some or all of the identified clusters under a constraint (C) that each ROI must be captured conform to a surveillance condition (e.g., cycling views of the NR camera with a minimum number of views during a timeframe, prioritized regions NR camera FOV). This configuration constraint (C) may ensure that the processing of the NR image 200 is appropriately weighted based on the configuration of the NR camera (i.e., the needs of the user/supervisor that installed the NR camera).

In one or more embodiments, the ROIs 220 may be selected to include all of the identified clusters under a constraint (C) that a minimum amount of the original NR image must be included among the ROIs. This configuration constraint (C) may ensure that the full FOV of the NR camera is utilized (i.e., nearly the entire office space can be monitored).

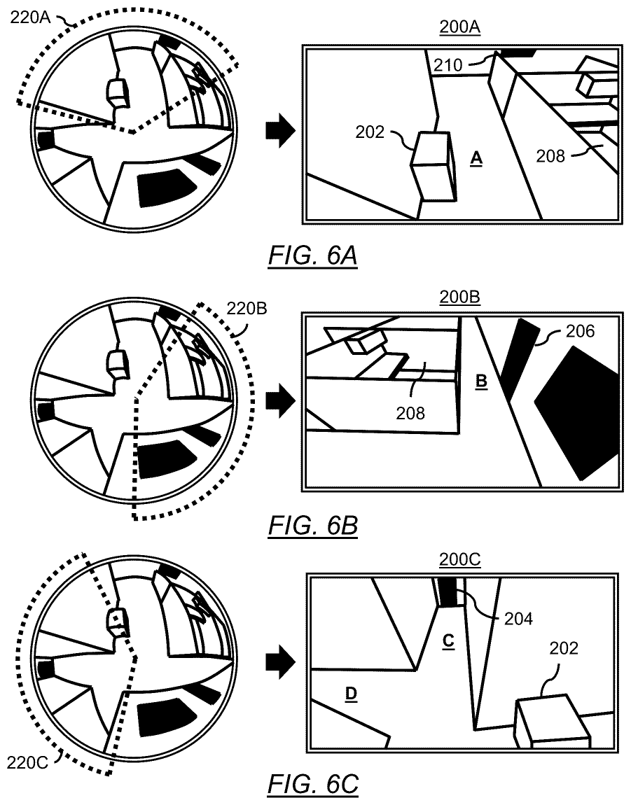

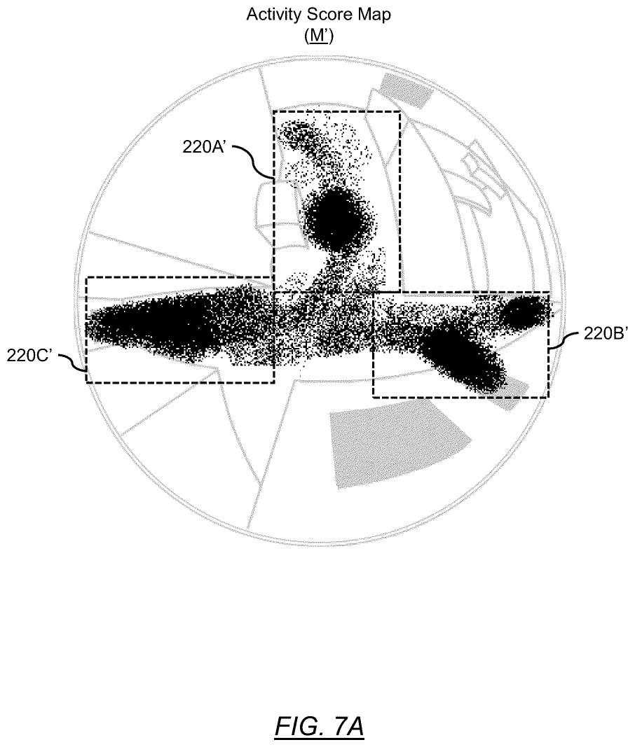

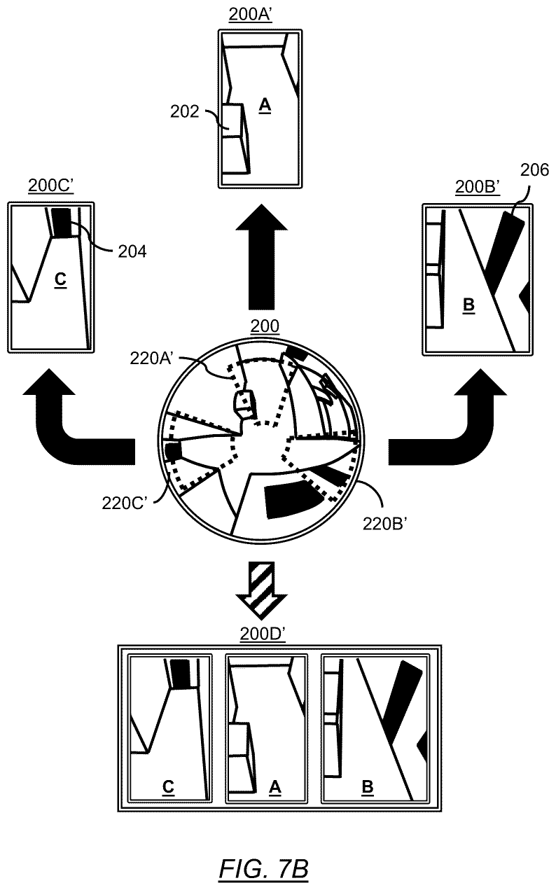

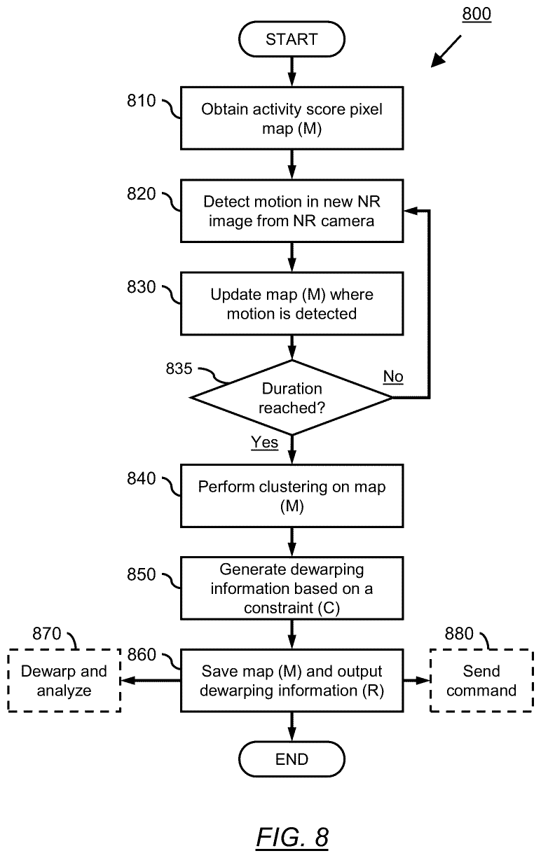

For example, in FIG. 5B, the ROIs 220A, 220B, 220C cover nearly the entire NR image 200 and include several overlapping regions. ROI 220A includes an NR view of pathway A and clusters M1, M2. ROI 220B includes an NR view of pathway B and clusters M1, M2, M3, M4. ROI 220C includes an NR view of pathways C, D and clusters M5, M6. The ROIs 220 may be bounding rectangles (as shown in FIG. 5B) or any appropriate shape (e.g., a shape matching a rectilinear output, as shown in FIGS. 6A-6C and FIG. 7).

While the present description contains a limited number of examples, those having ordinary skill in the art will appreciate that alternative examples of constraints may be used without deviating from the gist of the invention.

FIGS. 6A-6C show examples of rectilinear outputs in accordance with one or more embodiments of the invention.

As discussed above with respect to FIG. 5B, the ROIs 220A-C may be identified based on the activity score map (M) to focus surveillance on regions of higher activity in the office space while under a constraint (C) to maintain wide coverage across the office (i.e., attempt to match the FOV range of the NR camera). In FIGS. 6A-6C (left side), the respective ROIs 220A-C are shown overlaid on the original NR image 200.

In this case, the dewarping information (R) may simply include three angular regions of the FOV corresponding to ROIs 220A-C. In general, the dewarping information (R) for the NR camera may include coordinates of each ROI 220 within the FOV of the NR camera, dimensions of each ROI 220 (e.g., in the NR image and/or in the expected rectilinear output), transformation parameters (e.g., projection type, coefficients for a transformation), and/or labels (e.g., ROI identifiers, cluster identifiers, keywords).

In FIGS. 6A-6C (right side), the dewarping information (R) has been used in the transformation process to convert the ROIs 220A-C into the corresponding rectilinear outputs 200A-C. In this case, the dewarping information may simply include three angular regions of the FOV corresponding to ROIs 220A-C. In one or more embodiments, a perspective model is used to transform each angular region into its respective rectilinear output. In other words, the rectilinear outputs 200A-C are perspective corrected versions of ROIs 220A-C.

In one or more embodiments, the rectilinear outputs 200A-C are not perfectly perspective corrections of ROIs 220A-C. For example, when a constraint (C) exists to limit use of computational resources, a simpler transformation (e.g., an equirectangular projection model that “unwraps” the angular regions of the fisheye image) may be preferable to save on computational resources. In other words, the rectilinear output based on the dewarping information (R) may include an output image with some level of distortion. Therefore, a rectilinear output of one or more embodiments may be a two dimensional image with no distortion or an acceptable amount of distortion (e.g., defined by a constraint (C)).

FIGS. 7A-7B show examples of processing an NR image and rectilinear outputs in accordance with one or more embodiments of the invention.

In one or more embodiments, the constraint (C) may include a limitation on the computational resources (e.g., processing power and communication bandwidth requirements) utilized by the dewarping process. For example, in embodiments with dewarping performed by an onboard processor disposed in the NR camera (e.g., an IP camera, a network camera), there may be hardware limits (e.g., I/O, processor, memory limitations) or software limitations (e.g., limited parallel processing, fixed resolution requirements) to maintain uninterrupted operation of the NR camera. Therefore, as shown in FIG. 7A, the ROIs 220A′-C′ may be generated with a reduced size (e.g., relative to ROIs 220A-C in FIG. 5B). In one or more embodiments, the dewarping information (R′) corresponding to the activity score map (M′) may include ROIs selected based on a ranking of intensity values.

In FIG. 7B, the original NR image 200 is processed based on the dewarping information (R′) for ROIs 220A′-C′ to produce corresponding rectilinear outputs 200A′-C′. In this case, 200A′ focuses tightly on cluster M1 (e.g., monitoring subjects passing the multi-function peripheral device 202 in pathway A), while 200B′ focuses tightly on clusters M3, M4 (e.g., monitoring subjects in pathway B), and 200C′ focuses tightly on clusters M6 (e.g., monitoring subjects in pathway C). The rectilinear outputs 200A′-C′contain limited information (e.g., less range than 200A-C) with the added benefit of working within the constraints (C) of the NR camera. In one or more embodiments, the rectilinear outputs 200A′-C′ may be combined into a single output image 200D′ (e.g., concatenating the images). For example, the dewarping information (R′) may include parameters to generate a plurality of rectilinear outputs and a method of combining the plurality of rectilinear outputs.

In any of the above embodiments, integrating the activity score map (M) into the dewarping process results in more efficient use of computational resources. Furthermore, by focusing on clusters in the activity score map (M) and limiting analysis based on one or more constraints (C), embodiments of the invention produce improved outcomes from detection models that use the rectilinear output of the integrated dewarping process.

FIG. 8 shows a flowchart for a method 800 in accordance with one or more embodiments of the invention. The method 800 algorithmically configures ROIs for the NR camera based on information gathered from monitoring wide-angle view images over a period of time. In one or more embodiments, the method 800 may further be extended to executing the dewarping process, analyzing the rectilinear outputs, and acting upon the information learned from the analysis.

At 810, the system 100 obtains an activity score map (M) that corresponds to a view of an NR camera. Obtaining may include initializing a new map (i.e., generating a new file in the buffer 102) or retrieving a stored map from the buffer 102.

At 820, the system 100 obtains, from the NR camera, an NR image that includes the view of the NR camera. Because the NR image includes the view of the NR camera that corresponds to the activity score map (M), at least a portion of the NR image corresponds to the activity score map (M).

Furthermore, the system 100 detects motion in the NR image. As discussed above, the motion engine 104 may detect motion in the NR image by one or more algorithms (e.g., pixel difference with respect to a reference image or previous NR image from the NR camera).

At 830, the system 100 generates an updated activity score map (M) by incrementing the activity score map (M) based on the detected motion in the NR image. Updating the activity score map (M) (i.e., repeating blocks 820, 830) may be repeated any number of times. For example, each pixel of the activity score map (M) could be defined as the average number of times per hour an activity of interest (e.g., a moving object) is detected in NR image acquired during H number of hours.

At 835, a determination is made as to whether or not the predetermined duration has been reached. The predetermined duration may be quantified as a time period, number of iterations, or any appropriate metric to develop enough data in the activity score map (M). When the determination at 835 is NO (i.e., more data is required for the activity score map (M)), the process returns to 820. When the determination at 835 is YES (i.e., generating/updating the activity score map (M) is complete), the process continues to 840.

At 840, the system 100 performs clustering on the updated activity score map (M) to identify one or more ROIs in the NR image. As discussed above, the clustering engine 106 may utilize one or more clustering algorithms and define the center and/or boundaries of each cluster to define each corresponding ROI in the NR image.

At 850, the system 100 generates dewarping information (R) of one or more ROIs based on a constraint (C) of the NR camera. As discussed above, the ROI engine 108 may define each ROI such that the NR image can be reconfigured into one or more rectilinear outputs. In other words, the dewarping information (R) includes parameters (e.g., image coordinates, transformation settings/parameters) to convert each ROI into a rectilinear output.

In one or more embodiments, one or the constraints (C) of the NR camera may be based on a video stream capacity of a surveillance system that includes the NR camera. For example, if the surveillance system is only configured to process a predetermined number of images (e.g., one image from each camera install in the system), the constraint (C) may limit generating the dewarping information (R) to match the capacity of the surveillance system.

In one or more embodiments, where a plurality of ROIs are identified in the NR image, a predetermined number of ROIs may be selected based on the video stream capacity of the surveillance system. Therefore, dewarping information (R) maybe be generated for each of the predetermined number of ROIs to match the capacity of the surveillance system. For example, in one or more embodiments where a single image is expected from the NR camera but a plurality of ROIs exist, the dewarping information for each of the predetermined number of ROIs includes instructions for combining rectilinear outputs of the respective ROIs into a single output image, as described above with respect to FIG. 7B.

At 860, the system 100 outputs the dewarping information (R) of one or more ROIs. For example, in embodiments with dewarping performed onboard the NR camera or via a remote computing system, the system 100 sends the dewarping information to the NR camera or the computing system, respectively.

Optionally, at 870, the system 100 may proceed with dewarping the NR image (e.g., convert the ROI into the rectilinear output) and analyzing the rectilinear outputs. For example, a processor of the system 100 (e.g., installed in the NR camera or remote computing system) may use a projection model to convert the ROI into the rectilinear output based on the dewarping information). In one or more embodiments, the processor may transmit the rectilinear output. In one or more embodiments, the rectilinear output is input into an image recognition algorithm (e.g., any appropriate detection model or surveillance algorithm).

Optionally, at 880, the system 100 may send a command to the NR camera. As discussed above, the command engine 110 may provide feedback to the NR camera to improve image acquisition based on information learned during the dewarping process (e.g., based on an image quality parameter of the NR image or rectilinear output).

FIG. 9 shows a flowchart of a method 900 in accordance with one or more embodiments of the invention. The method 900 can adapt the activity score map (M) and implementation of the NR camera to a changing environment. Because most environments change over time, the ROIs and corresponding dewarping information (R) may require updating.

For example, optimal ROI configurations may change based on changes in the surveillance environment 1. The stored activity score map (M′) shown in FIG. 7A is different from the activity score map (M) of FIG. 5B. After a worker was moved into cubicle 208 and the renovations to pathway D completed, the stored activity score map (M′) no longer captures all of the active regions of the office space.

The change in traffic patterns may be accounted for by running method 900 in the background after an initial set of regions have been configured (e.g., by method 800). Whenever a significant change is detected from a previous activity score map (M), the system 100 can create a new set of ROIs and dewarping information. The method 900 may be applied during regular intervals (e.g., scheduled times), irregular intervals (e.g., asynchronous updates), on command (e.g., user intervention), or in response to any appropriate command of the system 100.

At 910, the system 100 obtains a stored activity score map (M′) that is different from the updated activity score map (M). The stored activity score map (M′) corresponds to stored dewarping information (R′).

Optionally, at 920, the system 100 may apply a filter to obtain smoothed maps (M) and (M′). For example, the system may apply a smoothing filter to obtain smoothed versions of the activity score maps to reduce noise in later processing steps.

At 930, the system 100 computes a difference score (D) between the stored activity score map (M′) and the updated activity score map (M). In one or more embodiments, the difference score (D) may be a normalized difference (e.g., a mean squared difference) between pixel values in the stored activity score map (M′) and the updated activity score map (M).

In one or more embodiments, the difference score (D) may be weighted by additional information included in the dewarping information (R, R′) or additional channels of the activity score maps (M, M′) (e.g., frequency, periodicity, labels).

In one or more embodiments, the clustering engine 106 may calculate a difference score (D) based on a difference in clustering between the stored activity score map (M′) and the updated activity score map (M).

At 935, a determination is made as to whether or not the difference score (D) is greater than or equal to the predetermined threshold. When the determination at 935 is YES (i.e., significant change between the activity score maps (M, M′)), the process continues to 940. When the determination at 935 is NO (i.e., not enough change between the activity score maps (M, M′)), the process continues to 950.

At 940, the system 100 replaces the stored activity map (M′) with the updated activity map (M). ROIs are subsequently identified based on the updated activity map (M).

At 950, the system 100 uses the stored dewarping information (R′) corresponding to the stored activity score map (M′). In other words, the previously used dewarping information (R′) is still considered applicable and using computational resources on new ROI determinations can be avoided.

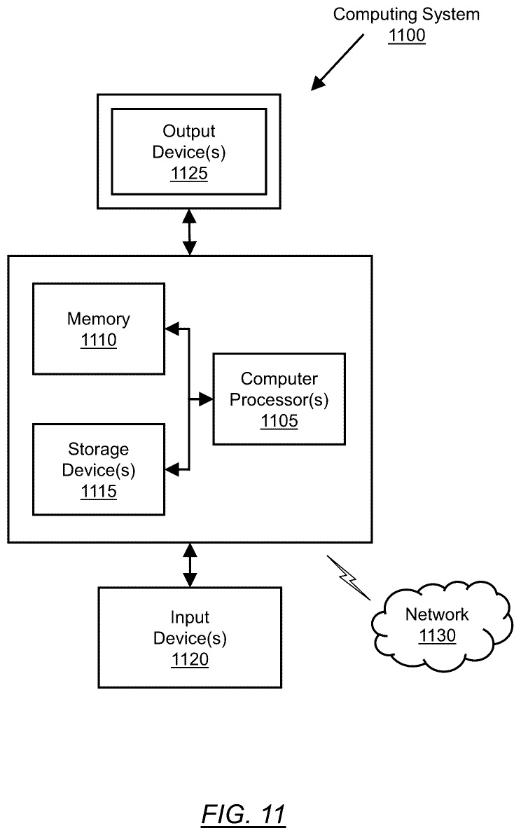

Although methods 800, 900 have been described with respect to a limited number of examples, those skilled in the art, having benefit of this disclosure, will appreciate that various other embodiments may be devised without departing from the scope of the present disclosure. Furthermore, while the various blocks in FIGS. 8-9 are presented and described sequentially, one of ordinary skill in the art will appreciate that some or all of the blocks may be executed in different orders, combined, omitted, and some or all of the blocks may be executed in parallel. The methods of FIGS. 8-9 may be implemented using instructions stored on a non-transitory medium that may be executed by a controller, a processor, or a computer system, as discussed in further detail below with respect to FIG. 11.

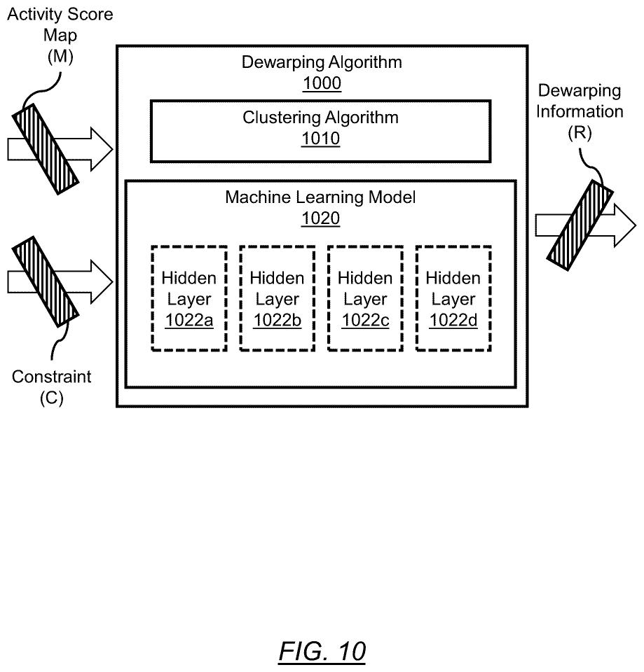

FIG. 10 shows a schematic of a dewarping algorithm 1000 in accordance with one or more embodiments of the invention.

In one or more embodiments, the dewarping algorithm 1000 accepts an activity score map (M) and constraints (C) as inputs and outputs dewarping information (R). The dewarping algorithm 1000 may be executed using the entire system 100, a subcomponent of the system 100, an additional functional block, or any combination thereof. The dewarping algorithm 1000 may include a clustering algorithm 1010 and/or a machine learning model 1020. For example, the clustering engine 106 may use the clustering algorithm 1010 to identify clusters of activity in the activity score map (M) while the ROI engine 108 generates the dewarping information (R).

In one or more embodiments, the ROI engine 108 may use ML model 1020 to generate the dewarping information (R). The ML model 1020 is designed to accept cluster information and constraints (C) and output dewarping information (R) that conforms to the constraints of the NR camera.

As shown in FIG. 10, in one or more embodiments, the ML model 1020 may include a neural network of one or more hidden layers 1022a-d (e.g., convolutional, pooling, filtering, down-sampling, up-sampling, layering, regression, dropout). In some embodiments, the number of hidden layers may be greater than or less than the four layers shown in FIG. 10. The hidden layers 1022a-d can be arranged in any order.

Each hidden layer 1022 includes one or more modelling neurons. The neurons are modelling nodes (i.e., neurons) that are interconnected to emulate the connection patterns of the human brain. Each neuron may combine data inputs with a set of network weights and biases for adjusting the data inputs. The network weights may amplify or reduce the value of a particular data input to alter the significance of each of the various data inputs for a task that is being modeled. For example, adding a constant to a particular data input shifts the activation function for an associated task being modeled. The activation function in turn determines whether and to what extent an output of one neuron affects other neurons (e.g., one neuron output may be a weight value for use as an input to another neuron or hidden layer). Through machine learning, the ML model 1020 may determine which data inputs should receive greater priority in determining one or more elements of the dewarping information.

While FIG. 10 shows an example configuration of the dewarping algorithm 1000, other configurations may be used without departing from the scope of the disclosure. For example, in the ML model 1020, a different type of model (e.g., deep learning model, categorization model) may be used in addition to or instead of a neural network. In one or more embodiments, the ML model 1020 may include the clustering algorithm 1010. Accordingly, the scope of the invention should not be limited by the specific dewarping algorithm 1000 depicted in FIG. 10.

FIG. 11 shows a computing system 1100 in accordance with one or more embodiments of the invention.

Embodiments of the invention may be implemented on virtually any type of computing system, regardless of the platform being used. For example, the computing system 1100 may be one or more mobile devices (e.g., laptop computer, smart phone, personal digital assistant, tablet computer, or other mobile device), desktop computers, servers, blades in a server chassis, or any other type of computing device(s) that includes at least the minimum processing power, memory, and input and output device(s) to perform one or more embodiments of the invention. For example, as shown in FIG. 11, the computing system 1100 may include one or more computer processor(s) 1105, associated memory 1110 (e.g., random access memory (RAM), cache memory, flash memory), one or more storage device(s) 1115 (e.g., a hard disk, an optical drive such as a compact disk (CD) drive or digital versatile disk (DVD) drive, a flash memory stick), and numerous other elements and functionalities. The computer processor(s) 1105 may be an integrated circuit for processing instructions. For example, the computer processor(s) 1105 may be one or more cores, or micro-cores of a processor. The computing system 1100 may also include one or more input device(s) 1125, such as a camera (e.g., an NR camera), imager, touchscreen, keyboard, mouse, microphone, touchpad, electronic pen, or any other type of input device. Further, the computing system 1100 may include one or more output device(s) 1125, such as a projector, screen (e.g., a liquid crystal display (LCD), a plasma display, touchscreen, cathode ray tube (CRT) monitor, or other display device), a printer, external storage, or any other output device. One or more of the output device(s) 1125 may be the same or different from the input device(s) 1120. The computing system 1100 may be connected to a network 1130 (e.g., a local area network (LAN), a wide area network (WAN) such as the Internet, mobile network, or any other type of network) via a network interface connection (not shown). Components of the computing system 1100 may be locally or remotely connected (e.g., via the network 1130) to the computer processor(s) 1105, memory 1110, and storage device(s) 1115. Many different types of computing systems exist, and the aforementioned structures may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

One or more of the embodiments of the invention may have one or more of the following improvements to image processing technologies: a method to automatically configure the regions by monitoring motion activities in the fisheye imagery for a predefined period of time; a method of generating a minimum set of output images to cover the areas with motion activities without losing valuable content in the original NR image; activity score metrics (e.g., number of activities-of-interest detected per time unit) can be defined and adapted to suit surveillance applications; configures activity data and dewarping information in coordinated manner to improve utility of existing or planned camera setups; a method to adapt configured region(s) to a changing environment, while the video processing system is in operation; configuring an optimal set of ROIs for a traffic pattern and allowing downstream processing to detect and process multiple objects in an unaltered view (no composite images) will likely lead to better outcome; generate distortion free, high resolution, high quality images for downstream AI modules. These advantages demonstrate that one or more embodiments of the invention are integrated into a practical application by improving resource consumption and reducing bandwidth requirements in the field of wide-angle surveillance systems.

Although the disclosure has been described with respect to a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of processing a video stream from a non-rectilinear (NR) camera, the method comprising:
obtaining an activity score map that corresponds to a view of the NR camera;
obtaining, from the NR camera, an NR image that includes the view of the NR camera;
detecting motion in the NR image;
generating an updated activity score map by incrementing the activity score map based on the detected motion in the NR image;
performing clustering on the updated activity score map to identify a region of interest (ROI) in the NR image;
generating dewarping information of the ROI based on a constraint of the NR camera, wherein the dewarping information includes parameters to convert the ROI into a rectilinear output; and
outputting the dewarping information of the ROI.

2. The method of claim 1, further comprising:
using a projection model to convert the ROI into the rectilinear output based on the dewarping information; and
inputting the rectilinear output into an image recognition algorithm, wherein
generating the dewarping information of the ROI is further based on a constraint of the image recognition algorithm, and
the dewarping information of the ROI includes boundary limits within in the NR image.

3. The method of claim 2, wherein
the boundary limits are based on an orientation constraint of the image recognition algorithm.

4. The method of claim 1, wherein
the constraint of the NR camera is based on a video stream capacity of a surveillance system that includes the NR camera.

5. The method of claim 4, further comprising:
identifying multiple ROIs in the NR image;
selecting a predetermined number of ROIs based on the video stream capacity of the surveillance system; and
generating dewarping information for each of the predetermined number of ROIs.

6. The method of claim 5, wherein
the dewarping information for each of the predetermined number of ROIs includes instructions for combining rectilinear outputs of the respective ROIs into a single output image.

7. The method of claim 1, wherein
the updated activity score map is generated based on detected motion in a plurality of NR images acquired over a predetermined duration.

8. The method of claim 1, further comprising:
identifying multiple ROIs in the NR image; wherein
the dewarping information generated for each of the multiple ROIs includes instructions for combining rectilinear outputs of the multiple ROIs into a single output image.

9. The method of claim 1, further comprising:
obtaining a stored activity score map that is different from the updated activity score map, wherein the stored activity score map corresponds to stored dewarping information;
computing a difference score between the stored activity score map and the updated activity score map; and
determining whether the difference score is greater than a predefined threshold;
when the difference score is greater than or equal to the predefined threshold, replace the stored activity score map with the updated activity score map and identify the ROI in the updated activity score map; and
when the difference score is less than the predefined threshold, use the stored dewarping information corresponding to the stored activity score map.

10. A non-transitory computer readable medium (CRM) storing computer readable program code for processing a video stream from a non-rectilinear (NR) camera, the computer readable program code causes a computer to:
obtain an activity score map that corresponds to a view of the NR camera;
obtain, from the NR camera, an NR image that includes the view of the NR camera;
detect motion in the NR image;
generate an updated activity score map by incrementing the activity score map based on the detected motion in the NR image;
perform clustering on the updated activity score map to identify a region of interest (ROI) in the NR image;
generate dewarping information of the ROI based on a constraint of the NR camera, wherein the dewarping information includes parameters to convert the ROI into a rectilinear output; and
output the dewarping information of the ROI.

11. The CRM of claim 10, wherein the computer readable program code causes the computer to:
use a projection model to convert the ROI into the rectilinear output based on the dewarping information; and
input the rectilinear output into an image recognition algorithm, wherein
the dewarping information of the ROI is further based on a constraint of the image recognition algorithm, and
the dewarping information of the ROI includes boundary limits within in the NR image.

12. The CRM of claim 11, wherein
the boundary limits are based on an orientation constraint of the image recognition algorithm.

13. The CRM of claim 10, wherein
the constraint of the NR camera is based on a video stream capacity of a surveillance system that includes the NR camera.

14. The CRM of claim 13, wherein the computer readable program code causes the computer to:
identify a plurality of ROIs in the NR image,
select a predetermined number of ROIs based on the video stream capacity of the surveillance system, and
generate dewarping information for each of the predetermined number of ROIs.

15. The CRM of claim 14, wherein
the dewarping information for each of the predetermined number of ROIs includes instructions for combining rectilinear outputs of the respective ROIs into a single output image.

16. The CRM of claim 10, wherein
the updated activity score map is generated based on detected motion in a plurality of NR images acquired over a predetermined duration.

17. The CRM of claim 10, wherein the computer readable program code causes the computer to:
identify multiple ROIs in the NR image; wherein
the dewarping information generated for each of the multiple ROIs includes instructions for combining rectilinear outputs of the multiple ROIs into a single output image.

18. The CRM of claim 10, wherein the computer readable program code causes the computer to:
obtain a stored activity score map that is different from the updated activity score map, wherein the stored activity score map corresponds to stored dewarping information;
compute a difference score between the stored activity score map and the updated activity score map; and
determine whether the difference score is greater than a predefined threshold;
when the difference score is greater than or equal to the predefined threshold, replace the stored activity score map with the updated activity score map and identify the ROI in the updated activity score map; and
when the difference score is less than the predefined threshold, use the stored dewarping information corresponding to the stored activity score map.

19. A system for processing a video stream of a non-rectilinear (NR) camera, the system comprising:
a memory; and
a processor coupled to the memory, wherein the processor is configured to:
obtain an activity score map that corresponds to a view of the NR camera;
obtain, from the NR camera, an NR image that includes the view of the NR camera;
detect motion in the NR image;
generate an updated activity score map by incrementing the activity score map based on the detected motion in the NR image;
perform clustering on the updated activity score map to identify a region of interest (ROI) in the NR image;
generate dewarping information of the ROI based on a constraint of the NR camera, wherein the dewarping information includes parameters to convert the ROI into a rectilinear output;
output the dewarping information of the ROI.

20. The system of claim 19, wherein
the processor is further configured to:
obtain a stored activity score map that is different from the updated activity score map, wherein the stored activity score map corresponds to stored dewarping information;
compute a difference score between the stored activity score map and the updated activity score map; and
determine whether the difference score is greater than a predefined threshold;
when the difference score is greater than or equal to the predefined threshold, replace the stored activity score map with the updated activity score map and identify the ROI in the updated activity score map; and
when the difference score is less than the predefined threshold, use the stored dewarping information corresponding to the stored activity score map.
